(19) United States
(12) Patent Application Publication
(10) Pub. No.: US 2003/0050044 A1
(43) Pub. Date: Mar. 13, 2003

(54) Wireless telephone system with a service provider automatically forwarding to each wireless telephone the exact billing time of a telecommunication upon the completion of the telecommunication

(75) Inventors: Faisal M. Awada, Round Rock, TX (US); Joe Nathan Brown, Austin, TX (US)

Correspondence Address: Volel Emile, IBM Corporation, Intellectual Property Law Dept., Internal Zip 4054, 11400 Burnet Road, Austin, TX, 78758, US

(73) Assignee: International Business Machines Corporation, Armonk, NY

(21) Appl. No.: 09/952,007

(22) Filed: Sep. 13, 2001

(51) Int. Cl. H04M 11/00

(52) U.S. Cl. 455/407; 455/406

(57) ABSTRACT

A wireless telephone system comprising a mobile wireless telephone for receiving and sending a plurality of data telecommunications including an implementation for storing the quantity of times of said plurality of data telecommunications, a telecommunications service provider for transmitting said plurality of telecommunications to and from other telephone terminals, facility in the service provider for keeping track of the quantity of times of said plurality of telecommunications together with a facility in said service provider for automatically sending tracked times to said means for storing the quantity of times in said mobile wireless telephone. At the completion of each of the plurality of communications, the facility for sending tracked times automatically sends the tracked times for each of said plurality of communications. The wireless telephone preferably includes a display, and there is an implementation enabling a user to display said stored quantity of times of said plurality of data communications. These stored quantities may be cumulative so that the user has access to a total of the minutes used which is reflective of the service provider's total so that no unexpected or excessive fees will come up.

### TECHNICAL FIELD

The present invention relates to telecommunications systems and particularly to mobile wireless telephone systems.

### BACKGROUND OF RELATED ART

With the globalization of business, industry and trade wherein transactions and activities within these fields have been changing from localized organizations to diverse transactions over the face of the world, the telecommunications industries have, accordingly, been expanding rapidly. While telecommunications technology development has been advancing to keep pace with expanded demands, communication channel bandwidth remains the commodity still in short supply. Bandwidth is the amount of data that can be transmitted via a given communications channel in a given unit of time (generally one second). Channel and bandwidth shortages still remain the factors that limit the efficiency of wireless long range mobile telecommunications and maintain the cost of such wireless communications at a premium.

Because of this scarcity of bandwidth, cost of wireless telecommunication per unit of time, usually minutes, is quite high. Also, in furtherance of maximizing the use and distribution of bandwidth, the various telecommunications service providers base rates upon anticipated availability of bandwidth during various time periods in the course of a week. These times of the week are broken down into maximum use bandwidth periods when billing rates for period of time are very high to minimum use bandwidth periods when rates should be low. In addition, because of very intense competition between wireless telecommunications providers for customers, and, particularly, in the cellular wireless telephone technology, customers are usually offered packaged wireless telephone usage, e.g. 400 minutes per month in high weekly usage periods and 1000 minutes per month during low usage weekly periods. It is very important to many users that they have a continuous or running accurate record of their call minutes usage during the allocated weekly time periods. In the absence of such accurate records, individual users can roll up to hundreds of dollars and businesses up to thousands in unexpected and unwanted excess fees each month. In packaged-wireless telephone plans the fees for excess usage are usually very high for the very purpose of levelling the distribution of available bandwidth over a time period.

In the richer and economically developed nations, the above-described excess usage charges may only be a great inconvenience to wireless telephone users. However, in the less developed nations, such unexpected excess charges may be very harmful to the user's finances and even determine the success or failure of businesses. In many of the more remote and underdeveloped areas of the world, wireless telecommunications lead, or at least are competitive with, the traditional wired systems in installations because it often requires less of an infrastructure to establish wireless telecommunications over wired telecommunication systems. Thus, it would be desirable from the business viewpoint of the wireless telecommunications industry to try to keep and expand its market share in such underdeveloped countries. Even if the profits from current wireless installations in underdeveloped countries are relatively low at present, the broader wireless customer base may be decisive in determining future directions in telecommunications as these countries undergo economic and industrial development.

### SUMMARY OF THE PRESENT INVENTION

The present invention offers one solution to the problem discussed above of unexpected and excessive usage fees due to the inability of the wireless telephone users to accurately track and, thus, control telecommunications usage during the time periods described above.

Accordingly, the present invention provides a wireless telephone system comprising a mobile wireless telephone for receiving and sending a plurality of data telecommunications including means for storing the quantity of times of said plurality of data telecommunications, a telecommunications service provider for transmitting said plurality of telecommunications to and from other telephone terminals, means in said service provider for keeping track of the quantity of times of said plurality of telecommunications together with means in said service provider for automatically sending tracked times to said means for storing the quantity of times in said mobile wireless telephone. At the completion of each of the plurality of communications, the means for sending tracked times automatically sends the tracked times for each of said plurality of communications. The wireless telephone preferably includes a display, and there are means enabling a user to display said stored quantity of times of said plurality of data communications. These stored quantities may be cumulative so that the user has access to a total of the minutes used that is reflective of the service provider's total so that no unexpected or excessive fees will come up. This feedback is particularly important since most service providers use means for keeping track of the quantity of times of said plurality of telecommunications which increase each fraction of a minute to the next higher minute. On the other hand, any currently available implements for keeping track of times of use in wireless telephone just tracked the exact times of use of the phone without adjustment to the highest minute. Over the course of a month, this could give rise to substantial differences between the time tracked at the wireless telephones and that tracked and, of course, billed by the service provider.

Also, there may be instances where the time tracked at the wireless telephone provides readings that are higher than that tracked at the service provider. For example, when the wireless telephone user dials up a number. In many systems, the service provider may not commence timing until the call is completed to the receiving station while the time tracked at the telephone is commenced as soon the call is dialed. This results in undue higher times at the transmitting wireless telephone which the present invention will prevent.

With the present invention, the times forwarded from the service provider to the wireless phone user automatically after each telecommunication are, per se, adjusted to the next highest minute. This is done to meet the billing protocols of the usual service provider. Of course, the present invention may be used to get the times available at the wireless telephone consistent with the service providers timing methods irrespective of whatever billing protocols the service provider may use.

According to a preferred aspect of the present invention, the means for storing the quantity of times stores said times in a plurality of weekly time categories, and the means for sending tracked times sends the tracked times for each of said plurality of weekly time categories. These weekly time categories include the weekly peak and off-peak time categories which are billing implementations. The invention is, of course, applicable to the generally used wireless telephone system, the cellular telephone system.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of a Public Switched Transmission Network showing channel paths to and from both conventional and mobile wireless channels on which the present invention is implemented;

FIG. 2 is a flowchart describing how the wireless telephone system of the present invention handles telecommunications involving a mobile wireless telephone member; and

FIG. 3 is a flowchart of a method of doing business according the present invention involving the updating of the individual wireless telephone as to minutes charged by the service provider automatically after each telecommunication, and the subsequent billing by the service provider to the wireless telephone user.

### DETAILED DESCRIPTION OF THE PREFERRED EMBODIMENT

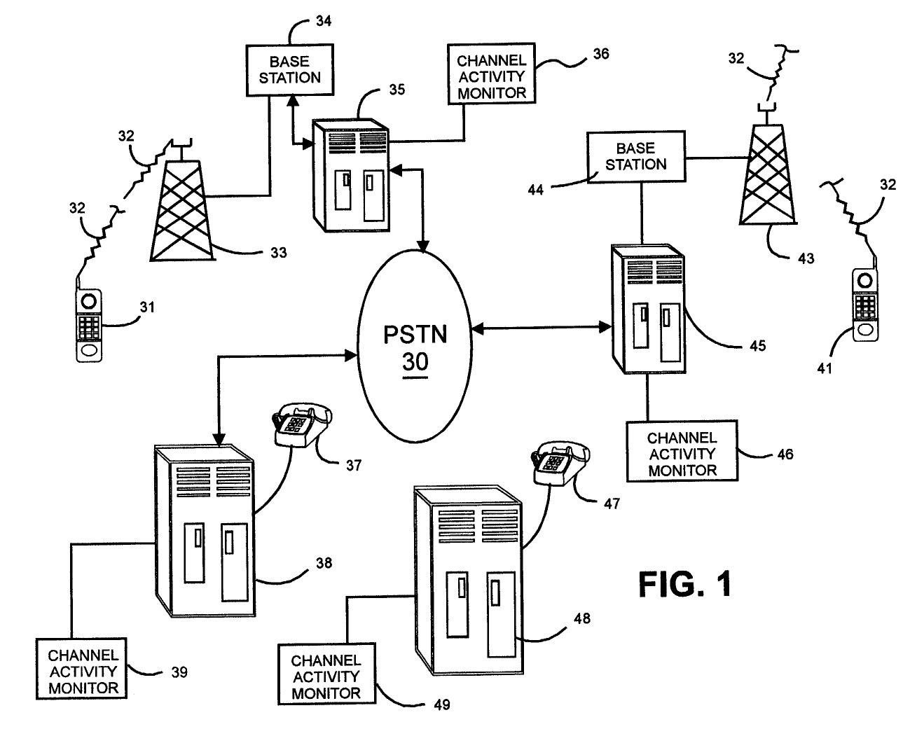

Referring to FIG. 1, there is shown a generalized diagrammatic view of a portion of a Public Switched Transmission Network (PSTN) showing channel paths to and from both conventional wired and mobile wireless channels and devices. Conventional telephones, e.g. phones 37 and 47, are connected to the PSTN 30 via local switching centers or switching nodes 38 and 48 in a fully wired telecommunications system. Conventionally, these switching nodes have many telephones 37 and 47 connected to each. The centers operate to control the channel connections, i.e. switch into and out of the PSTN 30 those calls originated or terminated at telephone stations 37. In a similar way, mobile cellular telephones 31 and 41 are connected into the PSTN 30. There are cellular telephone communication paths 32 from the respective cellular phone antenna 34 to antennae on towers 33 and 43. The distribution or routing of the telephone call to, from and within the PSTN 30 is quite similar to the routing of conventional wired telephone calls. Similarly, in the long range RF communication via cellular towers 33 or 43, the signals are passed through base stations 34 or 44 to switching center 38 or 45 which then controls the routing of the calls to PSTN 30. The conventional wired phones 37, 47 are also connected to their respective switching centers 38 and 48. The various switching centers within the PSTN may be monitored by channel activity state monitors, i.e monitors 36 and 46 for the wireless mobile telephones and 39 and 49 for the wired telephones to track activity for billing and other purposes. This is a cellular telephone system. Therefore, tower 43 and base 35 make up an area cell station.

At this point, it would be appropriate to consider some background with respect to wired and wireless telephones. The standard wired telecommunications system, which has been in use world wide for well over 100 years, is the conventional handheld or speaker input wired into a base, which, in turn, is wired into a PSTN with wired switched channel paths to and from other telephones or like devices through their bases. These telephones are respectively connected to the PSTN via local switching centers or switching nodes in a fully wired telecommunication system. Conventionally, these switching centers have many telephones connected to each. The centers operate to control the channel connections, i.e. switch into and out of the PSTN, those calls originated or terminated at telephone stations.

In addition, there have been developed over the past 20 years, the mobile wireless long range RF “wireless” telephone system, which has been commercialized primarily as the “cellular” telephone system. Before the cellular wireless phone system was developed, long range mobile wireless phones were relatively rudimentary; they were usually in automobiles. There was usually one central tower with about 25 channels available on the tower. The mobile wireless telephone needed a large powerful transmitter, usually in the automobile, which had to transmit up to 50 miles, which was too cumbersome for any personal or portable phone.

In the cellular system for the handheld mobile wireless phone, an area such as a city is broken up into small area cells. Each cell is about 10 square miles in area. Each has its base station that has a tower for receiving/transmitting and a base connected into PSTN. Even though a typical carrier is allotted about 800 frequency channels, the creation of the cells permit extensive frequency reuse so that tens of thousands of people in the city can be using their cell phones simultaneously. Cell phone systems are now preferably digital with each cell having over 160 available channels for assignment to users. In a large city there may be hundreds of cells, each with its tower and base station. Because of the number of towers and users per carrier, each carrier has a Mobile Telephone Switching Office (MTSO) that controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two-way long range RF communication. In the United States, cell phones are assigned frequencies in the 824-894 MHz ranges. Since transmissions between the cell telephone and cell tower are digital but the speaker and microphone in the telephone are analog, the cell telephone has to have a D to A converter from the input to the phone speaker, and an A to D converter from the microphone to the output to the cell tower.

Returning now to FIG. 1, channel activity monitors 36 and 46 respectively track the activities of wireless cell phones 31 and 41. This includes keeping track of the times of each telephone call or telecommunication irrespective of whether the communication is being sent or received. The channel activity monitor then sends this information back to the service provider's billing facility (not shown) where cumulative totals for the particular cell phones are tracked in its various predetermined time of the week period categories. It is standard in the cellular telephone industries to round off the time of each individual cell phone telecommunication to the next highest minute.

In accordance with the present invention, the cellular telephone has a conventional cell phone display, as well conventional cell phone storage. Thus, when the channel activity monitor forwards its time of call to the service provider for billing, it also forwards the identical information rounded off to the nearest minute back to the cell phone where this information is stored in the cell phone storage means also set up in cumulative totals for the particular cell phone as tracked in its various predetermined time of the week period categories. Accordingly, whenever the user wishes to check on his various time period billing totals, he displays these on the cell phone display where he gets his exact billing totals.

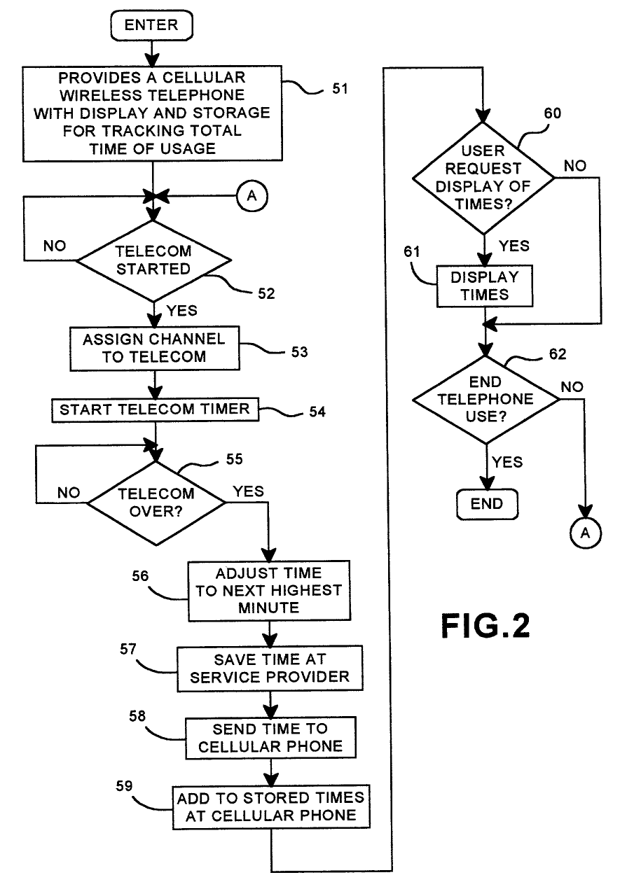

Now, with respect to FIG. 2, there will be generally described how the system handles a wireless phone call or other wireless communication. In a cellular telephone network system, there is provided a wireless cellular telephone with a display and storage capable of tracking cumulative times in several weekly time period categories, step 51. A determination is made, step 52, as to whether a telecommunication has commenced. If No, the process is returned to step 52 and the start of a telecommunication is awaited. If Yes, the telecommunication has started, then a channel is assigned to the telecommunication, step 53, and the telecommunication timer is started, step 54. Then, decision step 55, the end of the telecommunication is determined. If Yes, the telecommunication is over, the time on the timer is adjusted to the next highest minute, step 56, and this time is forwarded to and saved by the service provider, step 57. The exact time of step 57 is also sent to the cellular telephone, step 58, where the time is saved and accumulated in appropriate predetermined time of week categories, step 59. A determination is then made as to whether the user requests any of the accumulated times stored at the cell phone, step 60. If Yes, then these times may be displayed, step 61. At any convenient point, e.g. after No, step 60, or after step 61, a determination may be made, step 62, as to whether the user wishes to end the telecommunication; after a Yes, end telephone use, step 62, the telecommunication may be ended, or if No, the session process may be returned to step 52 via branch “A” where it is determined whether another telecommunication has started.

The process described with respect to FIG. 2 is just one example of the application of this invention. Variations may be incorporated to suit the protocols of particular wireless telephone systems. For example, in the process of FIG. 2 the actual time tracked by the service provider is sent to the wireless telephone upon the completion of the call or communication. This could present problems in certain systems with interrupted calls. With such an interrupted call, contact is lost with the service provider. Thus, the service provider cannot update the time stored at the wireless telephone. This problem may be readily solved by updating the wireless telephone time totals at the beginning of a telecommunication or both at the beginning and end of telecommunications. Also, the present invention is applicable to both transmitted and received telecommunications.

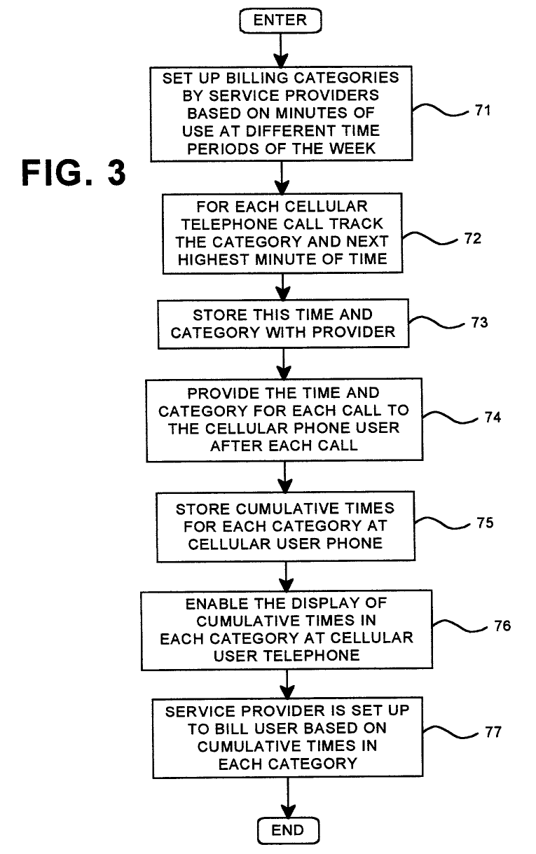

Now, with respect to FIG. 3, there will be described a method of doing business according the present invention involving the updating of the individual wireless telephone as to minutes charged by the service provider automatically after each telecommunication, and the subsequent billing by the service provider to the wireless telephone user. First, as between the customer-user and service provider, there are set billing categories based upon cumulative minutes of use in each of a set of different time periods during a week, step 71. Then for a cellular phone telecommunication, there is tracked the time category and the next highest minute of time for the telecommunication, step 72. This time and category is stored at the service provider, step 73. Provision is made for the forwarding to the cellular telephone that will be billed, the time and category for each call after the call is completed, step 74. Provision is made for the storage of the data received in step 74 at the receiving cellular phone, step 75. The cellular telephone is enabled, step 76, to display any of the information stored in step 75. The service provider is set up to bill the user based upon the cumulative times in each category.

While the invention has been described using the transmission of voice data, it should be understood that digital data, e.g. data processing and related data, may also be transmitted to and from the wireless phone number, along with voice data or even independently. With respect to cellular transmissions, there is, of course, a well developed commercially available technology for digital communication that could be used in the present wireless telephone when operating in the cellular mode.

Although certain preferred embodiments have been shown and described, it will be understood that many changes and modifications may be made therein without departing from the scope and intent of the appended claims.

What is claimed is:

1. A wireless telephone system comprising:
a mobile wireless telephone for receiving and sending a plurality of data telecommunications including:
means for storing the quantity of times of said plurality of data telecommunications;
a telecommunications service provider for transmitting said plurality of telecommunications to and from other telephone terminals;
means in said service provider for keeping track of the quantity of times of said plurality of telecommunications; and
means in said service provider for automatically sending tracked times to said means for storing the quantity of times in said mobile wireless telephone.

2. The wireless telephone system of claim 1 wherein said means for sending tracked times automatically sends the tracked times for each of said plurality of communications upon the completion of each communication.

3. The wireless telephone system of claim 2 wherein:
said mobile wireless telephone further includes a display, and means enabling a user to display said stored quantity of times of said plurality of data communications.

4. The wireless telephone system of claim 3 wherein said means for keeping track of the quantity of times of said plurality of telecommunications increase each fraction of a minute to the next higher minute.

5. The wireless telephone system of claim 4 wherein:
said means for storing the quantity of times stores said times in a plurality of weekly time categories; and
said means for sending tracked times sends the tracked times for each of said plurality of weekly time categories.

6. The wireless telephone system of claim 5 wherein said wireless telephone system is a cellular telephone system.

7. The wireless telephone system of claim 2 wherein said means for keeping track of the quantity of times of said plurality of telecommunications increase each fraction of a minute to the next higher minute.

8. In a wireless telephone system including a mobile wireless telephone for receiving and sending a plurality of data telecommunications, and a telecommunications service provider for transmitting said plurality of telecommunications to and from other telephone terminals, a method for providing the quantity of times of said plurality of telecommunications to a user of said mobile wireless telephone comprising:
storing the quantity of times of said plurality of data telecommunications in said mobile wireless telephone;
keeping track of the quantity of times of said plurality of telecommunications in said service provider; and
automatically adding said tracked times from said service provider to said stored quantity of times in said mobile wireless telephone.

9. The method of claim 8 wherein said step adding said tracked times automatically adds the tracked times for each of said plurality of communications upon the completion of each communication.

10. The method of claim 9 wherein said mobile wireless telephone further includes a display, and said method further includes the step of enabling a user to display said stored quantity of times of said plurality of data communications on said display.

11. The method of claim 10 wherein said step of keeping track of the quantity of times of said plurality of telecommunications increases each fraction of a minute to the next higher minute.

12. The method of claim 11 wherein:
said quantity of times are stored in a plurality of weekly time categories; and
said sent tracked times are the tracked times for each of said plurality of weekly time categories.

13. The method of claim 12 wherein said wireless telephone system is a cellular telephone system.

14. The method of claim 9 wherein said step of keeping track of the quantity of times of said plurality of telecommunications increases each fraction of a minute to the next higher minute.

15. In a wireless telephone system including a mobile wireless display telephone for receiving and sending a plurality of data telecommunications, and a telecommunications service provider for transmitting said plurality of telecommunications to and from other telephone terminals, a method for billing a user of said mobile wireless telephone comprising:
storing the quantity of times of said plurality of data telecommunications in said mobile wireless telephone;
keeping track of the quantity of times of said plurality of telecommunications in said service provider;
automatically adding said tracked times from said service provider to said stored quantity of times in said mobile wireless telephone;
enabling a user to display said stored quantity of times of said plurality of data communications on said display; and
billing said user based upon said stored quantity of times of said plurality of data communications on said display.

16. The method of claim 15 wherein said step of keeping track of the quantity of times of said plurality of telecommunications increases each fraction of a minute to the next higher minute.

17. The method of claim 16 wherein:
said quantity of times are stored in a plurality of weekly time categories; and
said sent tracked times are the tracked times for each of said plurality of weekly time categories.

18. The method of claim 17 wherein said wireless telephone system is a cellular telephone system.

19. A computer program having code recorded on a computer readable medium for providing the quantity of times of a plurality of telecommunications to a user of a mobile wireless telephone in a wireless telephone system including mobile wireless telephones for receiving and sending a plurality of data telecommunications and a telecommunications service provider for transmitting said plurality of telecommunications to and from other telephone terminals, said computer program comprising:
means in said mobile wireless telephone for storing the quantity of times of said plurality of data telecommunications;
means in said service provider for keeping track of the quantity of times of said plurality of telecommunications; and
means in said service provider for automatically sending tracked times to said means for storing the quantity of times in said mobile wireless telephone.

20. The computer program of claim 19 wherein said means for sending tracked times automatically sends the tracked times for each of said plurality of communications upon the completion of each communication.

21. The computer program of claim 20 wherein:
said mobile wireless telephone further includes a display, and means enabling a user to display said stored quantity of times of said plurality of data communications.

22. The computer program of claim 21 wherein said means for keeping track of the quantity of times of said plurality of telecommunications increase each fraction of a minute to the next higher minute.

23. The computer program of claim 22 wherein:
said means for storing the quantity of times stores said times in a plurality of weekly time categories; and
said means for sending tracked times sends the tracked times for each of said plurality of weekly time categories.

24. The computer program of claim 23 wherein said wireless telephone system is a cellular telephone system.

25. The computer program of claim 20 wherein said means for keeping track of the quantity of times of said plurality of telecommunications increase each fraction of a minute to the next higher minute.

26. A mobile wireless telephone for receiving and sending a plurality of data telecommunications comprising:
means for tracking the time period of each of said plurality of telecommunications;
means for adjusting the tracked time period of each telecommunication so as to correspond to a standard at which each telecommunication is billed; and
means for storing the adjusted total of the adjusted time periods of said plurality of telecommunications.

27. The mobile wireless telephone of claim 26 wherein said standard is the billing standard of a telephone communication service provider.

28. The mobile wireless telephone of claim 27 wherein the tracked time period of each telecommunication is adjusted to the nearest higher time unit.

29. A method for providing the quantity of times of a mobile wireless telephone uses for receiving and sending a plurality of data telecommunications comprising:
tracking the time period of each of said plurality of telecommunications;
adjusting the tracked time period of each telecommunication so as to correspond to a standard at which each telecommunication is billed; and
storing the adjusted the total of the adjusted time periods of said plurality of telecommunications.

30. The method of claim 29 wherein said standard is the billing standard of a telephone communication service provider.

31. The method of 30 wherein the tracked time period of each telecommunication is adjusted to the nearest higher time unit.
